(19) United States
(12) Patent Application Publication
(10) Pub. No.: US 2003/0119442 A1
(43) Pub. Date: Jun. 26, 2003

(54) Wireless local loop communication system

(75) Inventors: Woo Young Kwak, Kyonggi-do (KR); Sung Hoon Choi, Kyonggi-do (KR)

Correspondence Address: LEE & HONG, 801 SOUTH FIQUEROA STREET, 14TH FLOOR, LOS ANGELES, CA, 90017, US

(73) Assignee: LG Electronics Inc.

(21) Appl. No.: 10/165,246

(22) Filed: Jun. 7, 2002

(30) Foreign Application Priority Data
Dec. 21, 2001 (KR) 2001-82736

(51) Int. Cl. H04H 1/00

(52) U.S. Cl. 455/3.05; 455/462; 455/554

(57) ABSTRACT

A wireless local loop system having an integrated one-piece construction is provided. The system comprises a speaker, a microphone, and a RF transmission/reception mechanism for receiving a RF signal from an antenna, providing the signal after converting it to a digital baseband signal to a MSM (Mobile System Modem), and vise versa. The system further comprises a CODEC for coding and decoding analog and digital voice signals communicated between the microphone and the MSM, a data interface mechanism for connecting the WLL system to an external terminal, a memory for storing data related to user services and a main program for controlling the MSM, a power supplying mechanism having a charge battery for supplying power to the respective integrated system components.

### CROSS REFERENCE TO RELATED APPLICATION

Pursuant to 35 U.S.C. §119(a), this application claims the benefit of earlier filing date and right of priority to the Korean Application No. P2001-82736 filed on Dec. 21, 2001, the content of which is hereby incorporated by reference herein in its entirety.

### BACKGROUND OF THE INVENTION

1. Field of the Invention

The present invention relates to a wireless local loop communication system, and more particularly, to a wireless local loop communication system having an integrated one-piece construction in which a speaker and a microphone are built into the system.

2. Background of the Related Art

In general, a wireless local loop (WLL) system provides a wireless subscriber line that in a wireless manner connects a local switching center to a subscriber's premises (e.g., home or office) by way of radio waves to provide voice, facsimile, and data communication services.

The WLL is also known as RITL (Radio In the Loop), FRA (Fixed Radio Access), FWA (Fixed Wireless Access), or FCS (Fixed Cellular System) in some countries. Many communication service providers have become interested in the WLL system due to certain advantages that it provides over the currently used wired communication systems. The WLL system was designed by AT&T Bell Laboratory in the early 1970s for use in sparsely populated regions, such as fishing or rural villages, as an alternative to the current communication systems that require the installation of physical wire lines and cables. The intent was to save the cost associated with such installation throughout the sparsely populated areas by providing a wireless communication alternative.

Unfortunately, the WLL system was not a practical solution, at that time, due to difficulties associated with securing the right to use radio frequencies and also the high cost of manufacturing and installing antennas and radio transmitters and receivers. Semiconductor and electronic communication technologies, however, have developed rapidly since the 1990s. As a result of these developments, the efficiency and quality of wireless communication systems have improved. Today, manufacturers can produce more affordable wireless communication devices and equipment. At the same time, due to an increase in the number of subscribers and the reduction in the cost of production of radio equipment, total installation costs per subscriber is less expensive than ever. As such, the WLL system has started to draw the attention of many communication providers.

The WLL system can provide the following advantages over the current wired communication network systems. First, establishment of a wireless subscriber line and service is easier and faster than installation of a physical subscriber line that requires physically connecting a local switchboard to a subscriber's premises via a physical wire or cable. Second, the WLL system is a more durable and reliable system. For example, the WLL system can be used in case of emergency, if the current subscriber line networks are damaged due to a natural disaster, or the like. Third, the WLL system is technologically flexible to accommodate a variety of service requirements, such as POTS (Plain Old Telephone Service), data service, ISDN, and the like. Fourth, costs associated with installation of a WLL system is fixed, less dependent on distance and requires a relatively small initial investment. A quick and substantial return on the initial investment is, however, possible once the system starts to operate. Fifth, a WLL system network can be expanded quickly to accommodate an increase in subscriber communication bandwidth or subscriber base.

Because of the foregoing features, telephone and communication service providers, particularly those in developing countries that still utilize POTS, consider the WLL system as one of the most effective methods for the quick construction of a subscriber communication network. Although the WLL system is similar to a mobile communication network in that both systems use radio frequency as the communication medium, the advantage of WLL system is that it provides an electronic wave environment that is better than that of a mobile communication network because a WLL system does not require providing service to a mobile unit. Other advantages and features of the WLL system over a mobile communication network are discussed below.

A mobile communication network has a “non-line-of-sight” wave propagation environment. That is, the receiving and transmitting antennas in a mobile communication network are frequently located at a place lower than the surrounding buildings. As a result, generally, a straight carrier wave after transmission is blocked, reflected and refracted in its straight path before it reaches a receiver in the mobile communication environment. Due to these obstructions, an average wave path loss in a range of 40 dB/decade can occur in a mobile communication network.

A WLL system environment, however, has a wave path loss as low as 20 dB/decade, because it provides a “line-of-sight” propagation environment, wherein the receiving and transmitting antennas are located at rooftop levels and unobstructed by buildings and other natural or manmade obstacles. Further, since the mobility of antennas in the WLL system is limited (i.e., all the stations are stationary), the same power can be used to serve a larger area.

The electronic wave environment of the WLL system is implement over a point-to-point communication network structure, where each point is a stationary base station. Said environment is less susceptible to distortion and weak signal strength in comparison to the electronic wave environment of a mobile communication network that includes a point-to-mobile network structure, wherein the electronic waves may have to propagate in multiple paths before they reach the intended destination.

In a mobile communication network, much overhead is associated with managing signals and tracking a mobile station in anticipation of a hand-off procedure. A hand-off procedure ensures the continuity of service throughout the mobile communication network by establishing a new line of communication between a mobile station and a new base station when the mobile station moves out of the territory of an old base station and into the territory of the new base station. Since the WLL system does not support mobile stations, the WLL system does not require reserving radio channels that are necessary to handle the overhead associated with the hand-off procedure. Thus, all radio channels may be used to route general calls, thereby improving communication bandwidth and efficiency.

Further, in the WLL system, a direct radio link between a building and a base station can be established for reducing interference to a particular subscriber. Because there is no change in the radio link unless the number of subscribers substantially increases or the area covered by the base station (i.e., a cell) is divided, the design of the WLL is substantially simpler than a mobile communication network.

Moreover, the stationary radio communication of the WLL system permits the use of directional antennas on forward/reverse links for reducing identical channel interference to respective subscribers, and in turn allows for shortening the distance in which the same frequency can be reused. The reduction of frequency reuse distance results in an increase in subscriber capacity per unit area.

Typically, the WLL system comprises a telephone set, a NIU (Network Interface Unit), a base station, a base station controller and a base station managing device or equivalents thereof. The NIU makes wireless communication between the telephone set and a local switching center possible.

The NIU is an endpoint network element that operates to: communicate radio signals, modulate/demodulate radio frequencies, compress/decompress voice data and access a PSTN terminal. Depending on implementation, various types of terminals are utilized. For example, a particular terminal type may have a built-in RF function. Another type of terminal may be implemented with the RF function provided separately in a handset or equivalents thereof. In one or more embodiments, single or multiple communication lines may be provided.

The base station is located between the NIU and the base station controller. The base station communicates with the NIU by way of radio signals. The base station is connected to the base station controller by way of wire and operates to: communicate radio signals, control power, modulate/demodulate frequencies, transform protocol data for signal communication with the NIU and the base station controller. The base station is provided with an antenna transmitter/receiver, a power amplifier, channel cards, and hardware for interface with the base station controller.

When communicating with the NIU, the base station's effective communication range (i.e., cell radius) is limited by the electronic wave environment and radio power that is required to allow the base station controller to effectively access the wireless and wired sections of the system. The base station controller is located between the local switching center and the base station for connecting the local switching center and the base station and to manage the base station. The base station controller is connected to respective base stations, generally by way of wire. The base station controller manages radio resources, transcoding, base stations functionality and switchboard matches.

A base station managing device manages and maintains the operation of the entire WLL equipment. Such operations may include network system management, performance management, data processing, software management, security management, and the like.

A WLL system may be implemented in different embodiments depending on the connection mechanism between the telephone set and the NIU. A related art WLL system has a stationary telephone set and a separate NIU connectable to the stationary telephone by way wire. A subscriber may purchase the NIU separately, when the subscriber having the stationary telephone set connected to an existing wire network intends to subscribe to the WLL.

A related art WLL system is illustrated in FIGS. 1 and 2. FIG. 1 illustrates an external view of the related art WLL system, and FIG. 2 illustrates a block diagram of the internal components of the related art WLL system.

Referring to FIG. 1, similar to a general wired telephone set, the related art WLL system comprises a body 1 (connected to a telephone line), a handset 2 (separate from the body 1), and a coil line 3 (connected between the handset 2 and the body 1). Change in the status of a hook switch indicates if the handset 2 is on or off the body 1.

Referring to FIG. 2, the circuit of the related art WLL system comprises a RF transmission/reception mechanism 11, a MSM (Mobile System Modem) 12, a CODEC 13, a handset 14 connected to the CODEC 13 by a coil line, a hook detecting mechanism 15, a data interface mechanism 17, a memory 18, and a power supplying mechanism 16. A key pad 19 and a ringer 20 for providing a ring signal may be also included.

The RF transmission/reception mechanism 11 is configured for: (1) receiving a RF signal from an antenna with a transmission frequency 824-849 MHz and a reception frequency 869-894 MHz differed by super heterodyne system, producing an IF (Intermediate Frequency) signal converted into a digital baseband signal through an amplifier and an analog/digital converter, and providing the digital baseband signal to the MSM 12, and (2) converting a digital baseband signal received from the MSM 12 into an analog signal and an intermediate frequency signal, converting the IF signal into a RF band signal, and providing it to the base station through the antenna.

The MSM 12 is configured for: decoding the digital baseband signal from the RF transmission/reception mechanism 11 to produce information data, coding information data intended to transmit, converting the coded information data into a digital baseband signal, and providing the digital baseband signal to the RF transmission/reception mechanism 11.

The CODEC 13 is configured for: (1) coding an analog voice signal from the microphone in the handset into a digital voice signal, and providing the digital voice signal to the MSM 12, and (2) decoding a digital voice signal from the MSM 12 into an analog voice signal and adjusting levels of respective voice signals. The CODEC 13 comprises a speaker for presenting an analog voice signal from the CODEC, and a microphone for providing an analog voice signal to the CODEC 13.

The hook detecting mechanism 15 is configured for detecting on/off signal from a hook switch as the handset 2 is set on the body 1 or held up from the body 1, and providing the on/off signal to the MSM 12. The data interface mechanism 17 is configured for connecting the WLL system to an external instrument (such as computers and facsimile, or the like). The memory 18 stores a main program for controlling the MSM 12 and data related to user services. The power supplying mechanism 16 has a back up battery and a charging mechanism for receiving power from an AC adapter and supplying to respective mechanisms and the back up battery, for supplying power from the back up battery to respective mechanisms when the utility power fails.

The operation of the related art WLL system will be explained. At first, the reception mode will be explained.

Because the hook detecting mechanism 15 detects the on/off signal of the hook switch and forwards the signal to the MSM 12, the MSM 12 always checks the on/off signal of the hook switch. Accordingly, when an antenna signal is received from the base station when the hook switch is turned off, a ring signal is provided to a user. The RF transmission/reception mechanism 11 receives the RF signal, produces an intermediate frequency IF, converts it into digital baseband signal, and forwards it to the MSM 12.

The MSM 12 decodes the digital baseband signal from the RF transmission/reception mechanism 11 to produce information data, and forwards the information data to the CODEC 13. The CODEC 13 decodes the digital voice signal from the MSM 12 into an analog voice signal, adjusts levels of respective voice signals, and presents a voice signal through the speaker in the handset 2.

An analog voice signal received through the microphone in the handset 2 is coded by the CODEC 13 into a digital voice signal and is forwarded to the MSM 12. The MSM 12 receives and codes the digital voice signal, converts it into a digital baseband signal, and forwards it to the RF transmission/reception mechanism 11. The RF transmission/reception mechanism 11 receives the digital baseband signal from the MSM, converts it into analog and intermediate frequency signals, and then into a RF band signal intended for transmission to the base station through the antenna. Accordingly, the WLL system communicates with the base station.

In the meantime, if the user intends to setup a call, the user holds up the handset 2 to turn on the hook switch, and dials a telephone number on the key pad 19 for assignment of a channel to the base station. Alternatively, the WLL system may be connected to an external instrument (computer, facsimile, or the like) through the data interface mechanism 17 for communication purposes.

The following shortcomings are associated with the related art WLL system: First, the stationary WLL system is not convenient to use because it requires connection to an electrical outlet in order to operate; this limits its mobility. Second, due to its two-piece construction, the WLL system is too bulky and difficult to carry comfortably.

### SUMMARY OF THE INVENTION

The present invention relates to a battery operated wireless local loop (WLL) system with an integrated one-piece construction that allows a user the freedom of movement within a certain communication range.

In accordance with one embodiment, the system comprises a speaker, a microphone, and a RF transmission/reception mechanism for receiving a RF signal from an antenna, providing the signal after converting it to a digital baseband signal to a MSM (Mobile System Modem), and vise versa. The system further comprises a CODEC for coding and decoding analog and digital voice signals communicated between the microphone and the MSM, a data interface mechanism for connecting the WLL system to an external terminal, a memory for storing data related to user services and a main program for controlling the MSM, a power supplying mechanism having a charge battery for supplying power to the respective integrated system components, and a keypad having at least a button for establishing a communication connection.

In one embodiment, the MSM is configured to decode the digital baseband signal from the RF transmission/reception mechanism to produce information data, code information data for transmission, convert the coded information data into a digital baseband signal, and provide the digital baseband signal to the RF transmission/reception mechanism. Furthermore, in certain embodiments, the speaker is configured to present the analog voice signal from the CODEC, and the microphone is configured to provide the analog voice signal to the CODEC.

The features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood, however, that both the above summary and the following detailed description are exemplary and explanatory and are intended to provide further explanation of the invention as claimed and as such shall not be construed to limit the scope of the invention in any manner.

### BRIEF DESCRIPTION OF THE DRAWINGS

The accompanying drawings, which are included to provide a further understanding of the invention, are incorporated in and constitute a part of this specification.

FIG. 1 illustrates a three-dimensional external view of a related art WLL system;

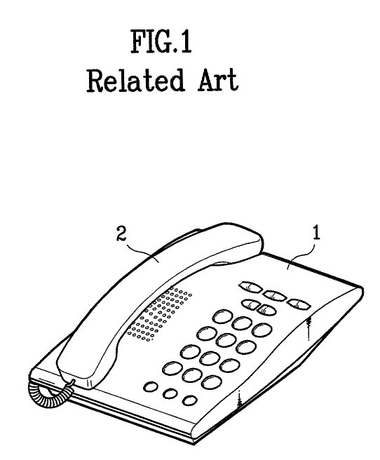

FIG. 2 illustrates a block diagram of a circuit designed for a related art WLL system;

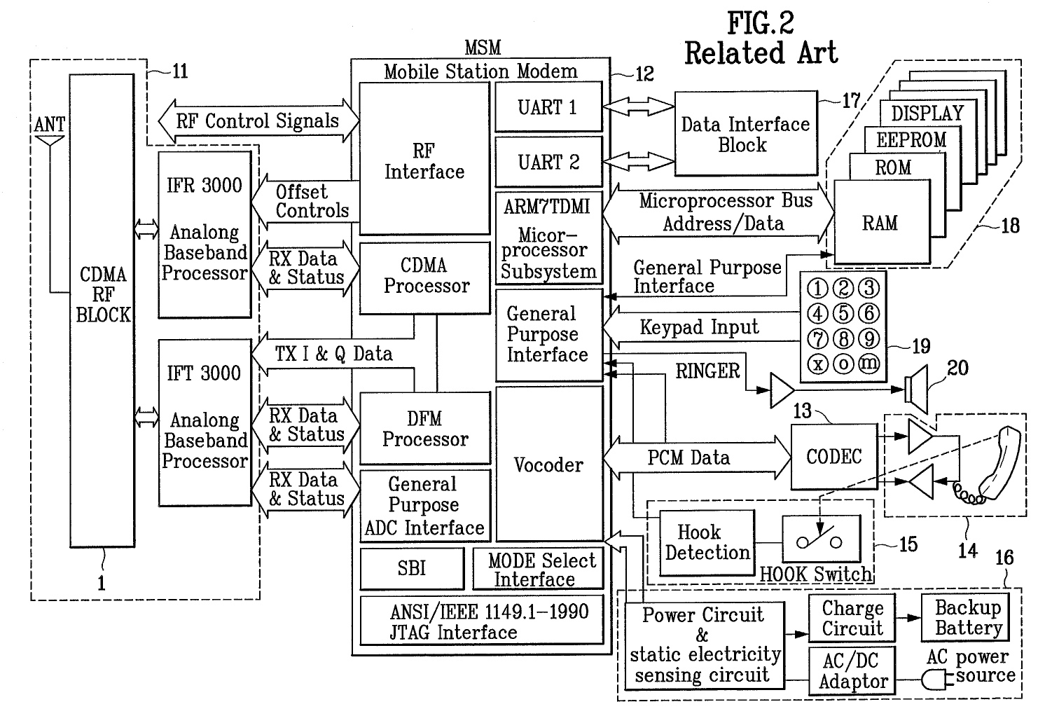

FIG. 3 illustrates a three-dimensional external view of a WLL system in accordance with an embodiment of the present invention; and

FIG. 4 illustrates a block diagram of an exemplary circuit designed for a WLL system in accordance with an embodiment of the present invention.

Features, elements, and aspects of the invention that are referenced by the same numerals in different figures represent the same, equivalent, or similar features, elements, or aspects in accordance with one or more embodiments.

### DETAILED DESCRIPTION OF THE PREFERRED EMBODIMENT

In the following, certain embodiments, aspects, advantages, and novel features of the invention have been provided. It is to be understood that not all such advantages may be achieved in accordance with any one particular embodiment. Thus, the invention may be embodied or carried out in a manner that achieves or optimizes one advantage or group of advantages as taught herein without necessarily achieving other advantages as may be taught or suggested herein. Reference will now be made in detail to the preferred embodiments of the present invention, examples of which are illustrated in the accompanying drawings.

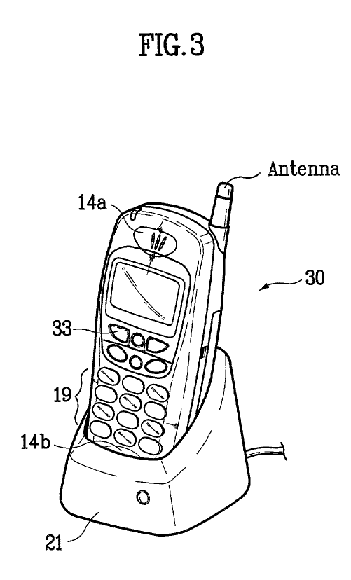

Referring to FIG. 3, the WLL system in accordance with an embodiment of the present invention includes a speaker 14a and a microphone 14b built into a body 30 having an integrated one-piece construction, wherein pressing a button 33, for example, on a keypad 19 causes a communication connection to be established between the WLL system and another communication device, such as a base station, for example. A battery charger 21 is provided separately for charging the WLL system through an external charging mechanism and to provide power to the WLL system.

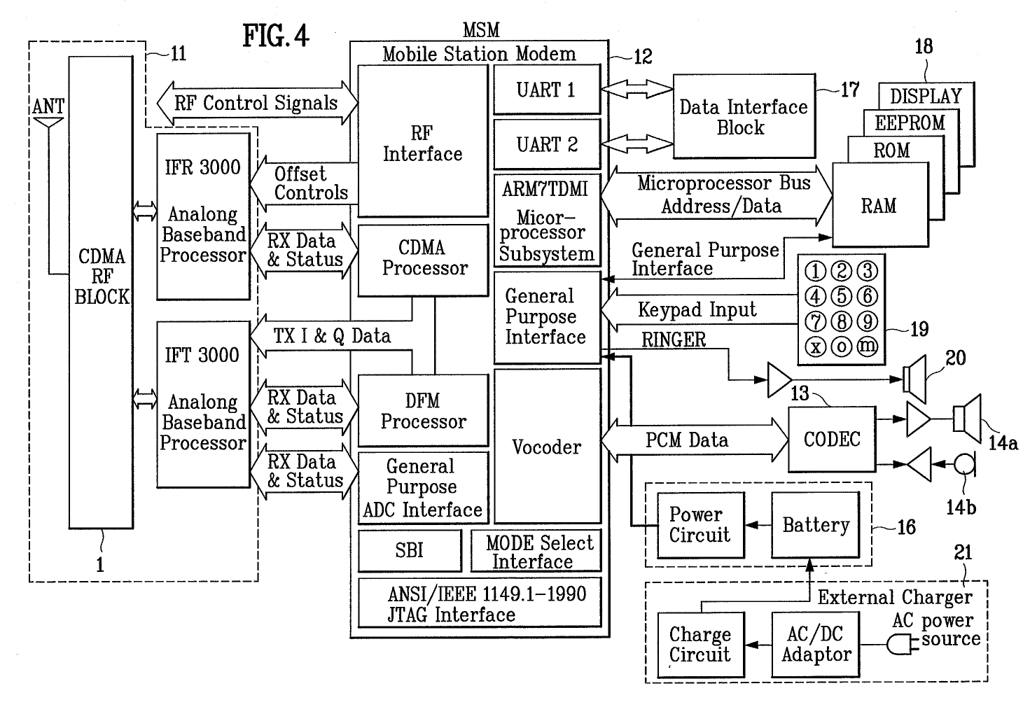

Referring to FIG. 4, the WLL system in accordance with an embodiment of the invention includes a RF transmission/reception mechanism 1. When voice data is received, the RF mechanism 11 is utilized for receiving a RF signal from an antenna, converting the RF signal into a digital baseband signal through an amplifier and an analog/digital converter, and providing the digital baseband signal to an MSM (Mobile System Modem) 12. When voice data is transmitted, the RF mechanism 11 is utilized for converting a digital baseband signal received from the MSM 12 into an analog signal and an intermediate frequency signal, converting the IF signal into a RF band signal, and providing the signal to the base station through the antenna.

The WLL system further comprises the MSM 12 for decoding the digital baseband signal from the RF transmission/reception mechanism 11 to produce information data, coding information data intended for transmission, converting the coded information data into a digital baseband signal, and providing the signal to the RF transmission/reception mechanism 11.

In some embodiments, the WLL system further comprises a CODEC 13 for coding an analog voice signal from a microphone into a digital voice signal, providing the digital voice signal to the MSM 12, decoding a digital voice signal from the MSM 12 into an analog voice signal and adjusting levels of respective voice signals.

Speaker 14a is included in one or more embodiments for presenting the analog voice signal from the CODEC 13; and microphone 14b is included for providing the analog voice signal to the CODEC 13. In some embodiments, the system further comprises a data interface mechanism 17 for connecting the WLL system to an external terminal (e.g., computers and facsimile, etc.), and a memory 18 for storing a main program for controlling the MSM 12. In some embodiments, RF calibration data and data related to user services is also stored in the memory 18. A power supplying mechanism 16 having a charge battery for supplying power to respective mechanisms is also included in one or more embodiments of the invention. In a preferred embodiment of the invention all the above-named components are integrated onto a single hardware unit in the WLL system.

The WLL system, in accordance with one or more embodiments, may further include a charger 21 external to the WLL system for charging the battery, a keypad 19 having at least one button, and a ringer 20 for providing a ring signal. Though not shown in the drawings, in one embodiment, the battery in the power supplying mechanism 16 and the external charger 21 are connected by way of a two-pin mechanism for charging a charge battery connected and preferably built-in to the WLL system.

In one or more embodiments, to make or receive a telephone call and to pre-dial or post-dial, the user presses a button 33, for example. Alternative dialing means, such as voice-activated dialing may also be utilized in certain embodiments. As such, the WLL system of the present invention comprises built-in speaker and microphone components and an external battery charger for charging a battery integrated into the system. Thus, the WLL system can be used conveniently like a general wireless telephone while moving within an area with the system's wireless communication range.

Although particular embodiments of the invention have been shown and described, it will be apparent to those skilled in the art that changes and modifications may be made without departing from the invention in its broader aspects, and therefore, the appended claims are to encompass within their scope all such changes and modifications that fall within the true scope of the invention.

What is claimed is:

1. A wireless local loop system having an integrated one-piece construction comprising a speaker and a microphone built into said system.

2. The local loop system of claim 1, further comprising:
a RF transmission/reception mechanism for:
receiving a RF signal from an antenna, producing an IF (Intermediate Frequency) signal, converting the IF signal into a digital baseband signal, and providing the digital baseband signal to a MSM (Mobile System Modem), and
converting the digital baseband signal received from the MSM into an analog and an IF signal, converting the IF signal into a RF band signal, and providing the RF band signal to a base station through an antenna.

3. The local loop system of claim 2, further comprising:
a CODEC for:
coding an analog voice signal from the microphone into a digital voice signal, and providing the digital voice signal to the MSM, and
decoding a digital voice signal from the MSM into an analog voice signal and adjusting levels of respective voice signals.

4. The local loop system of claim 3 where the MSM is configured to:
decode the digital baseband signal from the RF transmission/reception mechanism to produce information data,
code information data for transmission,
convert the coded information data into a digital baseband signal, and
provide the digital baseband signal to the RF transmission/reception mechanism.

5. The local loop system of claim 4 wherein:
the speaker is configured to present the analog voice signal from the CODEC; and
the microphone is configured to provide the analog voice signal to the CODEC.

6. The local loop system of claim 3, further comprising:
a data interface mechanism for connecting the WLL system to an external terminal;
a memory for storing data related to user services and a main program for controlling the MSM; and
a power supplying mechanism having a charge battery for supplying power to the respective integrated system components.

7. The local loop system of claim 6, further comprising a charger external to the integrated one-piece structure for charging the charge battery, wherein the charge battery and the external charger are connected via a two-pin mechanism for charging the charge battery.

8. The local loop system of claim 1, further comprising an interface for establishing a communication connection.

9. A wireless local loop system having an integrated one-piece structure, said one-piece structure comprising:
a speaker,
a microphone,
a RF transmission/reception mechanism for receiving a RF signal from an antenna providing the signal after converting it to a digital baseband signal to a MSM (Mobile System Modem),
a CODEC for coding and decoding analog and digital voice signals communicated between the microphone and the MSM,
a data interface mechanism for connecting the WLL system to an external terminal,
memory for storing data related to user services and a main program for controlling the MSM,
a power supplying mechanism having a charge battery for supplying power to the respective integrated system components, and
a keypad having at least a button to establish a communication connection.

10. The local loop system of claim 9, wherein:
the MSM is configured to decode the digital baseband signal from the RF transmission/reception mechanism to produce information data, code information data for transmission, convert the coded information data into a digital baseband signal, and provide the digital baseband signal to the RF transmission/reception mechanism, and wherein
the speaker is configured to present the analog voice signal from the CODEC and the microphone is configured to provide the analog voice signal to the CODEC.

11. A method of communication in a wireless local loop (WLL) system having an integrated one-piece construction comprising a built-in speaker and microphone to respectively present and capture analog voice signals, the method comprising:
receiving a RF signal from an antenna,
producing an IF (Intermediate Frequency) signal from the RF signal,
converting the IF signal into a digital baseband signal,
providing the digital baseband signal to a MSM (Mobile System Modem),
decoding the digital baseband signal from the MSM into an analog voice signal, and
adjusting levels of respective voice signals.

12. The method of claim 11, further comprising:
coding an analog voice signal captured by the microphone into a digital voice signal,
providing the digital voice signal to the MSM,
converting the digital voice signal received from the MSM into an analog signal and IF signal,
converting the IF signal into a RF signal, and
providing the RF signal to a base station through an antenna.

13. The method of claim 12, further comprising:
decoding the digital voice signal from a RF transmission/reception mechanism to produce information data, and
coding information data for transmission.

14. The method of claim 12, further comprising:
converting the coded information data into a digital baseband signal, and
providing the digital baseband signal to the RF transmission/reception mechanism.

15. The method of claim 11, further comprising presenting the analog voice signal via the speaker.

16. The method of claim 12, wherein the analog voice signal captured by the microphone is provided to a CODEC for conversion into digital signals.

17. The method of claim 11, further comprising connecting the WLL system to an external terminal via a data interface mechanism.

18. The method of claim 11, further comprising storing data related to user services and a main program for controlling the MSM in memory.

19. The method of claim 11, further comprising supplying power to respective integrated components of the system via a power supplying mechanism having a charge battery.

20. The method of claim 19, further comprising connecting the charge battery to an external charger via a two-pin connector mechanism for charging the charge battery.
